(19) United States
(12) Patent Application Publication
(10) Pub. No.: US 2005/0062990 A1
(43) Pub. Date: Mar. 24, 2005

(54) Image forming apparatus and computer product

(76) Inventors: Takezo Fujishige, Kanagawa (JP); Kiyoshi Kasatani, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/912,079

(22) Filed: Aug. 6, 2004

(30) Foreign Application Priority Data
Aug. 8, 2003 (JP) 2003-290256

(51) Int. Cl. H04N 1/60

(52) U.S. Cl. 358/1.9; 358/518

(57) ABSTRACT

An image forming apparatus includes an image processing unit that sets a predetermined equal value for pixels in a color image data having red, green, and blue saturation values less than a predetermined first value. A printer engine forms an image with black for pixels that have been set with the equal value to form an image with any one of yellow, magenta, and cyan for pixels other than the pixels that have been set with the equal value.

### CROSS-REFERENCE TO RELATED APPLICATIONS

The present document incorporates by reference the entire contents of Japanese priority document, 2003-290256 filed in Japan on Aug. 8, 2003.

### BACKGROUND OF THE INVENTION

1) Field of the Invention

The present invention relates to an image forming apparatus that can print two-color images.

2) Description of the Related Art

A printer that can print two-color images from full-color data has been disclosed in Japanese Patent Application Laid-open Publication No. 2002-240361.

Although full-color image data is available, sometimes it is desired to print two-color images on an electrophotography-type image forming apparatus that can form a full-color image by superimposing toners of four colors viz. yellow (Y), magenta (M), cyan (C), and black (K).

For example, sometimes it is desired to make a copy of a document that is printed in black and white with comments made in red or blue color. If an image is formed with toners of only two colors from among the toners of four colors Y, M, C, and K, it is possible to save the toners and reduce the running cost.

However, if the image is formed with two colors, i.e., M and K when the original data is full-color, then a portion of the image other than a portion that is to be printed with the toner of M color is also printed with the toner of M color. In other words, the toner of M color is deposited not only on the portion of red comments but also on black and white portion of the document, thereby spoiling the overall image.

The reason for this is that, when the image formation is performed by the toners of only two colors, a gray image which is comparatively darker in color is formed by the toner of K color and a gray image which is comparatively brighter in color formed by the toner of M color.

### SUMMARY OF THE INVENTION

It is an object of the present invention to provide an image forming apparatus that can print clear two-color images.

An information processing apparatus according to an aspect of the present invention includes an image processing unit that sets a predetermined equal value for pixels in a color image data having red, green, and blue saturation values less than a predetermined first value; and a printer engine that forms an image with black for pixels that have been set with the equal value to form an image with any one of yellow, magenta, and cyan for pixels other than the pixels that have been set with the equal value.

A computer program according to another aspect of the present invention contains instructions which when executed on a computer causes the computer to execute setting a predetermined equal value for pixels in a color image data having red, green, and blue saturation values less than a predetermined first value.

A computer-readable storage medium according to still another aspect of the present invention stores therein the above computer program according to the present invention.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a configuration of a system that includes a digital color copy machine according an embodiment of the present invention;

FIG. 2 is a perspective view of the digital color copy machine;

FIG. 3 is a functional block diagram of the digital color copy machine;

FIG. 4 is a top view of an operation panel;

FIG. 5 is a flow chart of a series of steps involved in two-color printing;

FIG. 6 is a detailed flow chart of a two-color process shown in FIG. 5;

FIG. 7 is a flow chart of a full graying process; and

FIG. 8 is a flow chart of an image formation process of two-color printing shown in FIG. 5.

### DETAILED DESCRIPTION

Exemplary embodiments of an image forming apparatus and a computer product according to the present invention are explained below while referring to the accompanying drawings.

The present embodiment is an example in which an information processing apparatus is used in a so called digital color copy machine that includes various functions such as of photocopying, faxing, printing, scanning, and transmitting an image that is input (an image that is read by scanning a document, or an image that is input by an own function as a printer or an own function as a FAX).

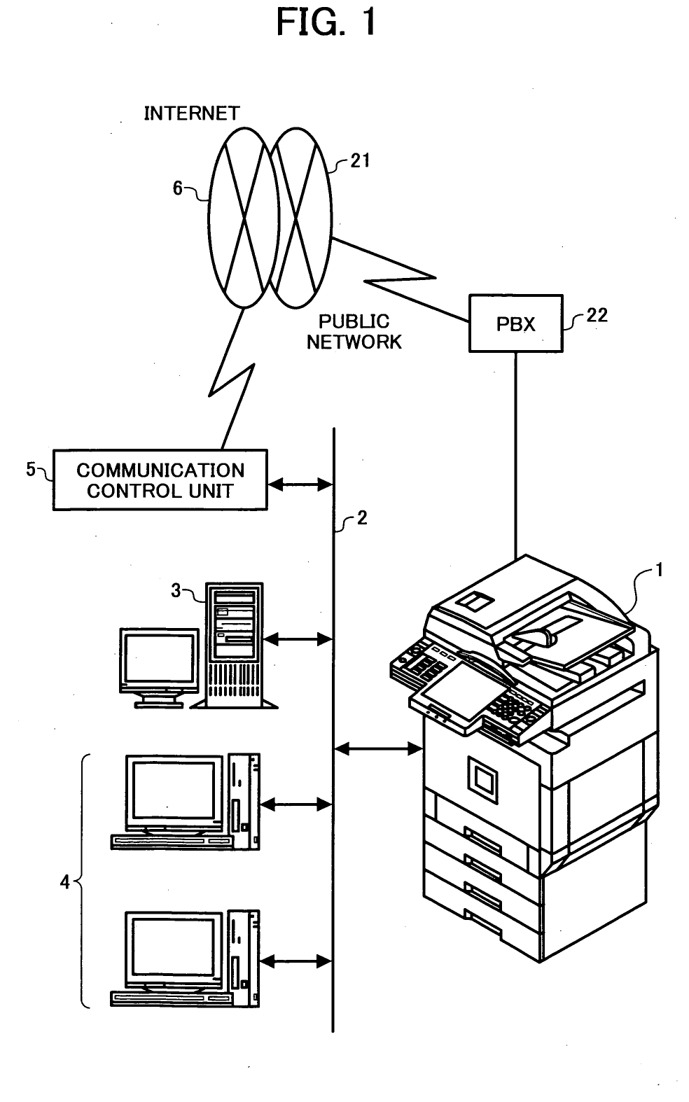

FIG. 1 is a configuration of a system that includes a digital color copy machine 1 according to an embodiment of the present invention. The system includes a server computer 3 and client computers 4 that are connected to the digital color copy machine 1 via a local area network (LAN) 2. The server computer 3 and the client computers 4 are information processing apparatuses that execute various kinds of information processing. The server computer 3 supports protocols such as a file transfer protocol (FTP) and a hyper text transfer protocol (HTTP). The server computer 3 can function as a Web server, a mail server, and a domain name server (DNS). In other words, the system provides an environment in which image processing functions, such as image input, image output, and image storage, in the digital color copy machine 1, can be shared over the LAN 2.

The system is connected to the Internet 6 via a communication control unit 5, thereby enabling data communication with an external environment. The communication control unit 5 is a router, a modem, or a digital subscriber line (DSL) modem. However, any other structure that supports transmission control protocol/internet protocol (TCP/IP) communication may also be used. The LAN 2 may be wired or wireless. Wireless communication can be achieved, for example, by infrared rays and radio waves. Wired communication can be achieved, for example, using optical fibers.

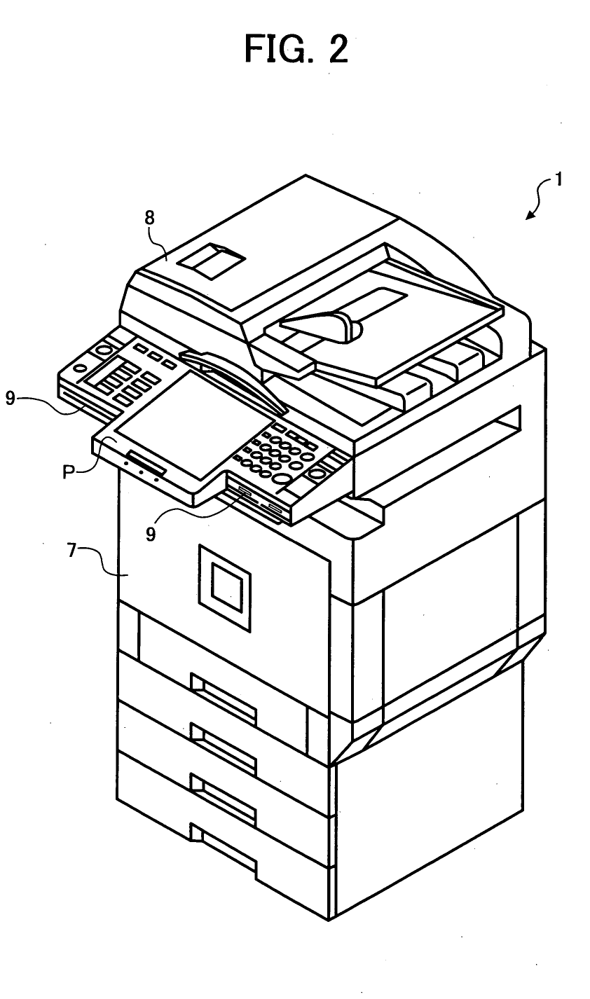

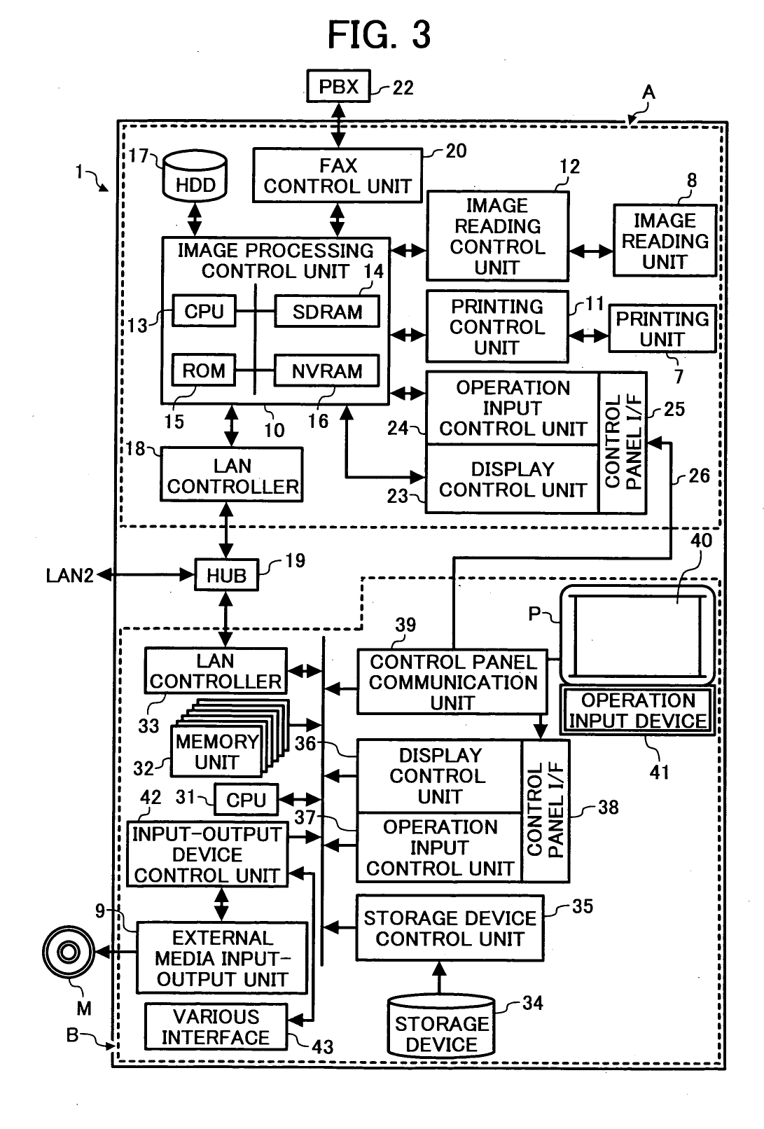

The digital color copy machine 1 will now be described in detail. FIG. 2 is a perspective view of the digital color copy machine 1 and FIG. 3 is a functional block diagram of the digital color copy machine 1. As shown in FIG. 2, the digital color copy machine 1 includes a printing unit 7, an image reading unit 8, an operation panel P, and an external media input-output unit 9. The printing unit 7 is an image forming unit that forms an image on a medium such as a transfer paper. The image reading unit 8 is disposed above the printing unit 7, and reads an image of a document. The external media input-output unit 9 is disposed below the operation panel P. The external media input-output unit 9 can read image files and program codes form a storage medium M (refer to FIG. 3), and can write image files and program codes on the storage medium M. The external media input-output unit 9 has an opening through which a storage medium M can be inserted. This opening is located at such a position that a storage medium M can be inserted in it easily.

The digital color copy machine 1 includes an image processing unit A and an information processing unit B as shown in FIG. 3. The printing unit 7 and the image reading unit 8 are included in the image processing unit A. The operation panel P and the external media input-output unit 9 are included in the information processing unit B.

The image processing unit A further includes an image-processing control unit 10 that controls image processing in the image processing unit A. A printing control unit 11 and an image-reading control unit 12 are connected to the image-processing control unit 10. The printing control unit 11 controls the printing unit 7 and the image-reading control unit 12 controls the image reading unit 8.

The printing control unit 11 outputs printing instructions including image data to the printing unit 7 according to a control by the image-processing control unit 10, causes the printing unit 7 to form an image on a medium like a transfer paper and to output it. The printing unit 7 includes a printer engine that is capable of full-color printing and various printing methods apart from the electrophotography, such as ink-jet printing method can be used.

The image-reading control unit 12 drives the image reading unit 8 under the control of the image-processing control unit 10. The image reading unit 8 optically reads the image of the document. Precisely, a lamp irradiates a light on the document, and the light reflected from the document is. received by a photoreceptor via a mirror or a lens. The photoreceptor is, for example, a charge coupled device (CCD). The image-reading control unit 12 performs analog to digital conversion of the read image, and creates digital image data of eight bits of each of red, green, and blue (RGB).

The image-processing control unit 10 is a microcomputer that includes a central processing unit (CPU) 13, a synchronous dynamic random access memory (SDRAM) 14 as a memory device, a read only memory (ROM) 15, and a non-volatile random access memory (NVRAM) 16 which are connected by a bus. The CPU 13 is the main processor. The SDRAM 14 stores the image data. The ROM 15 stores control programs etc. The NVRAM 16 holds data which has information such as system log, system setting, and log information recorded in it, even when the power supply is put OFF.

A hard disk drive (HDD) 17, a LAN controller 18, and a FAX control unit 20 are connected to the image-processing control unit 10. The HDD 17 stores job history and image data in a large quantity. The LAN controller 18 connects the image processing unit A to the LAN 2 via a HUB 19 inside the unit that is a line concentrator. The FAX control unit 20 performs the FAX control. The FAX control unit 20 is connected to an exchanger (PBX) 22 that leads to a public telephone network 21, thereby enabling the digital color copy machine 1 to communicate with a remote FAX.

Further, a display control unit 23 and an operation-input control unit 24 are connected to the image-processing control unit 10. The display control unit 23 outputs an image-display control signal to the information processing unit B via a communication cable 26 that is connected to a control panel I/F 25 by the control by the image-processing control unit 10, and performs the control of the image display of the operation panel P of the information processing unit B. The operation-input control unit 24 inputs an input control signal according to the function setting and the input operation by an operator from the operation panel P in the information processing unit B via the communication cable 26, which is connected to the control panel I/F 25, by the control by the image-processing control unit 10. In other words, the image processing unit A can directly monitor the operation panel P via the communication cable 26.

Therefore, in the image processing unit A, the communication cable 26 is connected to the image processing unit that is included in the conventional image processing apparatus, and the operation panel P in the information processing unit B is used. In other words, the display control unit 23 and the operation-input control unit 24 in the image processing unit A operate as units connected to the operation panel P.

The image processing unit A analyzes a command that carries printing instructions and printing data as image information from the external devices (the server computer 3, the client computer 4, and the facsimile etc.), performs bitmap conversion of the printing data so that the printing data can be printed as output image data, then analyses the printing mode from the command, and determines the operation. The printing data and the command are received either via the LAN controller 18 or via the FAX control unit 20.

The image processing unit A can transfer document reading data and printing data stored in the SDRAM 14 and the HDD 17, can output image data that is processed for outputting the document reading data and the printing data, and compressed data obtained by compressing the document reading data and the printing data, to external devices (i.e. to the server computer 3, the client computer 4, and to the facsimile etc.).

Further, the image processing unit A transfers the image data that is read by the image reading unit 8 to the image-processing control unit 10. The image processing unit A, then, applies correction to the signal deterioration caused due to quantization of an optical system and a digital signal, and writes this image data in the SDRAM 14. Thus, the image data stored in the SDRAM 14 is converted into output image data in the printing control unit 11, and is output to the printing unit 7.

The information processing unit B is now explained in detail. The information processing unit B has a structure of a microcomputer that is controlled by a general-purpose operating system (OS) which is used in an information processing unit called as a personal computer in general. The information processing unit B includes a CPU 31 which is a main processor. The CPU 31 includes a memory unit 32 and a storage-device control unit 35 that are connected by the bus connection. The memory unit 32 includes a read only memory (ROM) that is a memory exclusively for reading and has a start-up computer program and random access memory (RAM) that is a working area of the CPU 31, stored in it. The storage-device control unit 35 controls input and output of data to and from a storage device 34 such as an HDD which stores the OS and an application program.

A LAN controller 33 that connects the information processing unit B to the LAN 2 via the HUB 19 is connected to the CPU 31. An Internet protocol (IP) address that is a network IP address assigned to the LAN controller 33 is different from the IP address that is assigned to the LAN controller 18 of the imaged processing unit A. Thus, the digital color copy machine 1 is assigned with two IP addresses. In other words, the image processing unit A and the information processing unit B are connected to the LAN 2 and the data exchange between the image processing unit A and the information processing unit B is possible.

Since the digital color copy machine 1 is connected to the LAN 2 via the HUB 19, apparently it looks as if only one IP address is assigned. Therefore, wiring connections etc. can be made easily without disturbing the neat appearance.

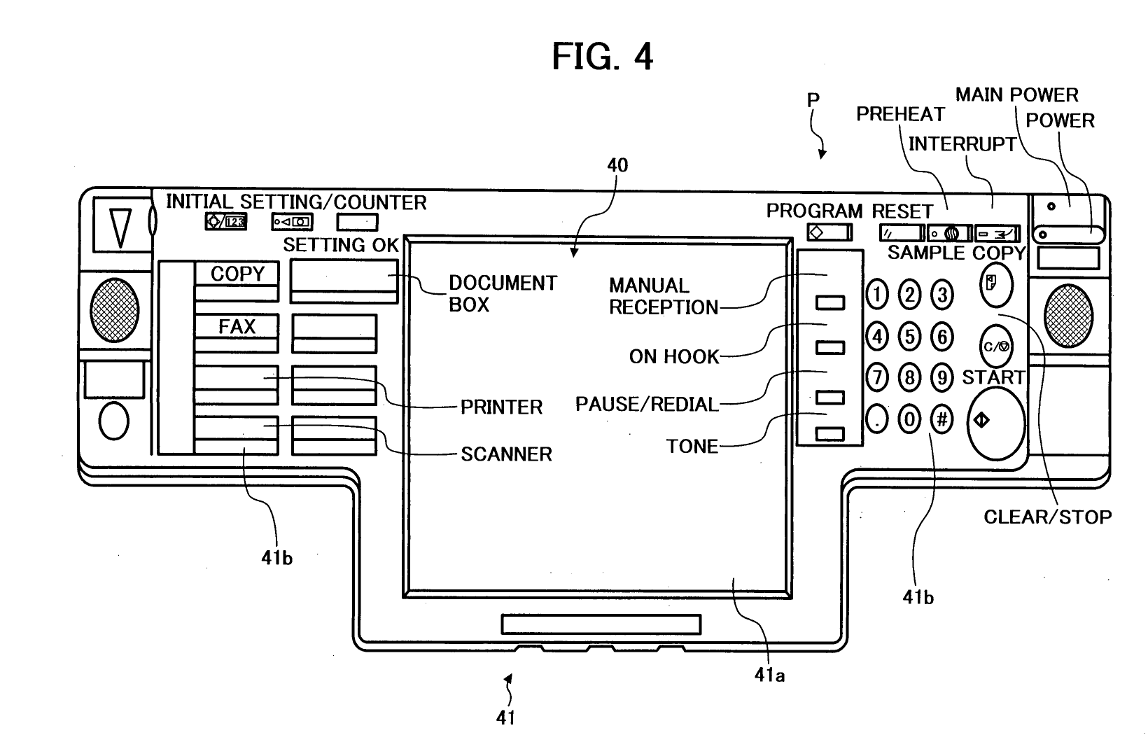

Moreover, an operation-input control unit 37 and a display control unit 36 that controls the operation panel P are connected to the CPU 31. FIG. 4 is a top view of the operation panel P. The operation panel P includes a display unit 40, which is, for example, a liquid crystal display (LCD), and an operation-input device 41. The operation-input device 41 includes a touch panel 41a and a keyboard 41b. The touch panel 41a is of a type such as ultrasonic and acoustic waves laminated on the display unit 40 and the keyboard 41b includes a plurality of keys. The keyboard 41b includes keys such as a start key to indicate start of image reading, a numeric key pad to input values, a reading-condition setting key to set destination to which the image data read is transmitted, and a clear key. Thus, the display control unit 36 outputs the image-display control signal to the display unit 40 via a control panel I/F 38, and displays, on the display, predetermined items in accordance with the image-display control signal unit 40. On the other hand, the operation-input control unit 37 receives an input control signal according to the function setting and the input operation by the operator at the operation-input unit 41 via the control panel I/F 38.

A control panel communication unit 39 that is connected to the control panel I/F 25 in the image processing unit A via the communication cable 26 is connected to the CPU 31. The control panel communication unit 39 receives the image-display control signal that is output from the image processing unit A, and transmits an input control signal according to the function setting and the input operation by the operator at the operation panel P to the image processing unit A. More concretely, the image-display control signal from the image processing unit A that is received at the control panel communication unit 39 is subjected to data conversion to be displayed on the display unit 40 in the operation panel P, and then, is output to the display control unit 36. The input control signal according to the function setting and the input operation by the operator at the operation panel P is subjected to data conversion to correspond to a format according to the specifications in the image processing unit A, and then, is input to the control panel communication unit 39.

Thus, the application program and the OS to be executed by the CPU 31 are stored in the storage device 34. In this context, the storage device 34 functions as a storage medium that stores the application program. In this digital color copy machine 1, when the user turns power on, the CPU 31 starts a start-up program stored in the memory unit 32, and reads the OS stored in the storage device 34 into the RAM inside the memory unit 32 to start the OS. The OS enables the computer program to be executed according to the user's operation, reads and saves information. Windows (registered trademark) is an example of a typical OS. Operation program running on such the OS is called as an application program. The OS for the information processing unit B is a same OS as the OS for the information processing unit (such as the server computer 3 and the client computer 4), i.e. a general-purpose OS such as Windows (registered trademark).

The digital color copy machine 1 includes the external media input-output unit 9 that can handle a flexible disk drive, an optical disk drive, a magneto-optical disk drive, and a semiconductor media drive. These types of drives read code included in a computer program and an image file etc. which are stored in the storage medium M such as a flexible disk (FD), a hard disk, an optical disk (such as a compact disc−read only memory (CD−ROM), compact disc−recordable (CD−R), digital versatile disc−read only memory (DVD−ROM), digital versatile disc−read only memory (DVD−ROM), digital versatile disc−random access memory (DVD−RAM), digital versatile disc−recordable (DVD−R), DVD+R, digital versatile disc−rewritable (DVD−RW), and DVD+RW), a magneto-optical disk (MO), and a semiconductor medium. Program codes (control computer program) such as various application programs of OS and drives, and image files are stored in the storage medium M. Such the external media input-output unit 9 functions as a reading unit that reads data stored in a medium. The external media input-output unit 9 is controlled by an input-output device control unit 42 that is connected to the CPU 31 by the bus connection.

The application program to be stored in the storage device 34 may be an application program obtained by installing an application program stored in the storage medium M. Therefore, the storage medium M can also function as the storage medium that stores the application program. Moreover, the application program may be obtained from an external source via the Internet 6 and the LAN 2 to be installed in the storage device 34.

Various interfaces 43, such as a universal serial bus (USB), IEEE 1394, and a small computer system interface (SCSI), are connected to the input-output device control unit 42. Various external equipments (such as a digital camera) can be connected via these interfaces 43.

The printer engine of the printing unit 7 can form an image on a medium like a paper by superimposing Y, M, C, and K colors. However, in the digital color copy machine 1, only two-color printing, i.e. printing with K color and any one of Y, M, and C color can be performed. The following is a description of the two-color printing.

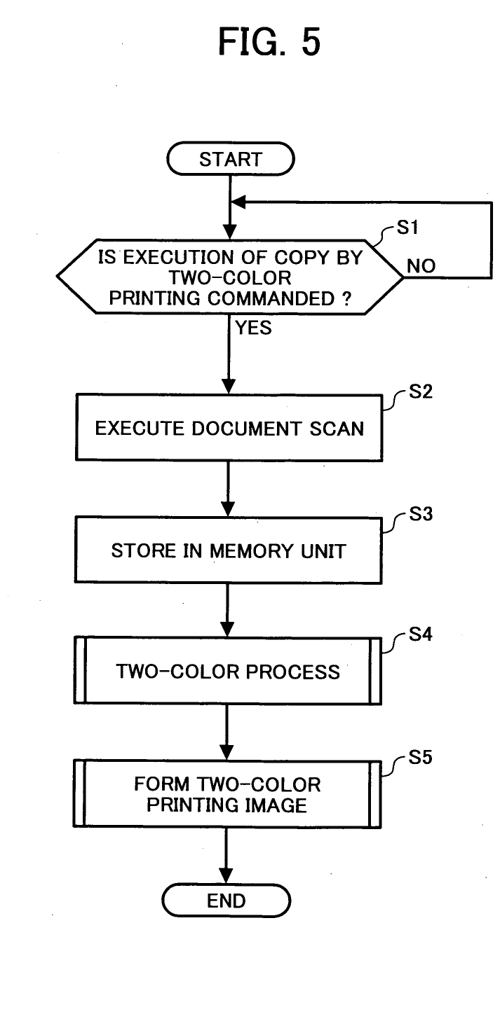

FIG. 5 is a flow chart of a series of steps involved in the two-color printing. The series of steps involved in the two-color printing, particularly a two-color process is executed by an application program that is read from the storage medium M or downloaded from the Internet 6 and installed in the storage device 34. As shown in FIG. 4, to start with, as a user commands execution of copy by two-color printing by operating the operation input unit 41 (Yes at step S1, the CPU 31 causes the image processing unit A to execute document scan by the image reading unit 8 (step S2), the color image data that is read is received by the information processing unit B and is stored in the memory unit 32 (step S3). Further, the color image is subjected to an image processing of two-color processing (step S4). The color image data subjected to two-color processing is then output to the image processing unit A. Based on the color image data subjected to two-color processing, the printing unit 7 is caused to perform image processing of two-color printing which is described later (step S5).

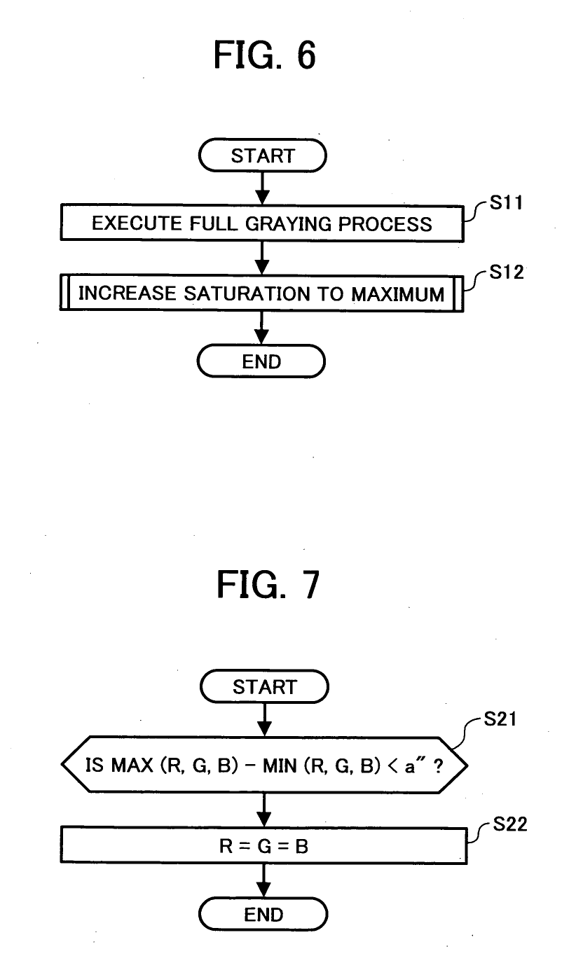

FIG. 6 is a flow chart of two-color processing (step S4) in detail. To start with, based on the color image data received from the image processing unit A, the CPU 31 executes a full graying process to obtain a full gray version of colors close to gray color for each pixel of the color image data (a first image processing unit) (step S11).

The full graying process is described in a flow chart in FIG. 7. The CPU 31 makes a judgment of whether a difference between the maximum values of R, G, and B for each pixel and the minimum values of R, G, and B for each pixel in the color image data is less than a where a is a predetermined constant value (step S21).
MAX(R, G, B)−MIN(R, G, B)<a (1)
In other words, the CPU 31 makes a judgment of whether it is a pixel for which the difference between the maximum value MAX (R, G, B) and the minimum value MIN (R, G, B) in each of the R, G, B values in the color image data is less than a predetermined value a. The saturation of an image can be calculated by MIN (R, G, B)/MAX (R, G, B). However, to accelerate the calculation of saturation, the division is substituted by subtraction in the equation (1).

Further, pixels which fulfill the relationship in equation (1) (Y at step S21), i.e. pixels which have saturation less than the predetermined value, are subjected to a process of conversion of R, G, and B values to equal values (step S22).

The conversion at step S22 can be performed by any of (1) and (2) below:

(1) R, G, B values are converted to equal values by making values of R and G equal to B.

(2) Each of R, G, B value is multiplied by a different specific value for each of R, G, and B. The products obtained by multiplication are all added and the values obtained by addition of the product values are R, G, and B, thereby converting R, G, and B to equal values. Concretely, a value b obtained in equation (2) is let to be a value of R, G, and B.
0.3×R+0.6×G+0.1×B=b (2)
(in this equation, R,G, and B indicate R, G, and B values of a pixel)

Coming back to FIG. 5, after executing the full graying process (step S11), the CPU 31 executes an image processing to increase the saturation of the color image data to its maximum limit (second image processing unit) (step S12).

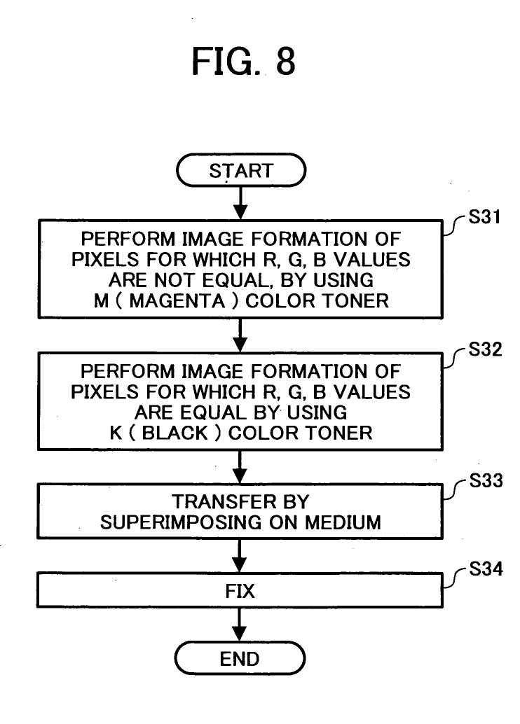

The following is a description of the image formation process of two-color printing (step S5) with reference to FIG. 8. In this process, a two-color image is formed with only two colors viz. K and any one of Y, M, and C by the printer engine of the printing unit 7. In this case, the user may select any one of Y, M, and C to be used by operating the operation input device 41 or a color among the Y, M, and C to be used may be set. In the description given below, it is assumed that M is used. Moreover, a case where the printer engine of the printing unit 7 uses electrophotography is described in the description.

As shown in FIG. 7, among the color image data for the image formation, pixels for which R, G, and B values are not equal are subjected to a toner image formation by using toner of M color (step S31). Pixels for which R, G, and B values are equal are subjected to a toner image formation by using toner of K color (step S32). The toner image of M color and the toner image of K color are transferred by superimposing on a medium like a paper (step S33) and fixed (step S34). Various known technologies for color image formation by electrophotography can be used to super impose the toner image of M color and the toner image of K color. If a color image is formed by using one photosensitive drum, for example, as the toner image of M color and the toner image of K color are formed on the photosensitive drum, they are transferred to an intermediate transfer belt, and the toner image of M color and the toner image of K color are superimposed.

If an ink-jet printer is used, a similar process may be performed to form an image by superimposing upon discharging ink of any one of Y, M, and C color and ink of K color on a medium such as a paper.

By performing the two-color printing in this manner, a gray image which is comparatively brighter in color is formed by K color only and only a portion of the image which has real shades is formed by any one of Y, M, and C colors. Therefore, a clear two-color image can be formed.

Moreover, the saturation of each pixel can be calculated by subtracting the minimum value of each of R, G, and B from the maximum value of each of R, G, and B (step S21). Therefore, it is possible to accelerate the process.

Further, the shades can be emphasized by increasing the saturation of the image (step S12), thereby enabling to form even better two-color image.

According to the present invention, even for the gray image comparatively brighter in color, the image is formed by the toner of only K color and a portion of image which has real shades is formed by any one of Y, M, and C colors, thereby forming a clear two-color image.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. An image forming apparatus comprising:
an image processing unit that sets a predetermined equal value for pixels in a color image data having red, green, and blue saturation values less than a predetermined first value; and
a printer engine that forms an image with black for pixels that have been set with the equal value to form an image with any one of yellow, magenta, and cyan for pixels other than the pixels that have been set with the equal value.

2. The image forming apparatus according to claim 1, wherein the image processing unit sets the predetermined equal value for pixels with a difference between a maximum value and a minimum value of each of red, green, and blue values less than a predetermined second value.

3. The image forming apparatus according to claim 1, further comprising a saturation increasing unit that increases the saturation of image in the color image data.

4. The image forming apparatus according to claim 1,wherein the image processing unit sets the predetermined equal value, by making values of red and green equal to black, for pixels with a difference between a maximum value and a minimum value of each of red, green, and blue values less than a predetermined second value.

5. The image forming apparatus according to claim 1, wherein each of red, green, and blue values is multiplied by a different specific value for each of red, green, and blue, products obtained by multiplication are added and values obtained by addition of the products are red, green, and blue values thereby converting red, green, and blue values to equal values for the pixels for which the difference between the maximum value and the minimum value of each of red, green, and blue is less than the predetermined first value.

6. A computer program that contains instructions which when executed on a computer causes the computer to execute:
setting a predetermined equal value for pixels in a color image data having red, green, and blue saturation values less than a predetermined first value.

7. The computer program according to claim 6, wherein the setting includes setting the predetermined equal value for pixels with a difference between a maximum value and a minimum value of each of red, green, and blue values less than a predetermined second value.

8. The computer program according to claim 6, further causes the computer to execute increasing the saturation of image in the color image data.

9. A computer-readable storage medium that stores a computer program that contains instructions which when executed on a computer causes the computer to execute:
setting a predetermined equal value for pixels in a color image data having red, green, and blue saturation values less than a predetermined first value.

10. The computer-readable storage medium according to claim 9, wherein the setting includes setting the predetermined equal value for pixels with a difference between a maximum value and a minimum value of each of red, green, and blue values less than a predetermined second value.

11. The computer-readable storage medium according to claim 9, further causes the computer to execute increasing the saturation of image in the color image data.
